(19) United States
(12) Patent Application Publication
(10) Pub. No.: US 2005/0030729 A1
(43) Pub. Date: Feb. 10, 2005

(54) Surface emitting device

(76) Inventors: Tia-Cheng Yu, Tu-Chen (TW); Charles Leu, Fremont, CA (US); Ga-Lane Chen, Fremont, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/637,851

(22) Filed: Aug. 7, 2003

(51) Int. Cl. F21V 7/04

(52) U.S. Cl. 362/31

(57) ABSTRACT

A surface emitting device includes a light source unit (21) and an optical light guide plate (22) coupling with light from the light source unit to produce a uniform light source surface. The light source unit comprises a light source (24) and a lamp cover (25). The lamp cover is substantially shaped as a hexahedron and defines a groove, which faces towards the light source. The groove is covered with a reflective film (255). With the reflective film, the groove functions as a concave mirror, and the light source is positioned along a focal line of the concave mirror.

### BACKGROUND OF THE INVENTION

1. Field of the Invention

The present invention relates to a light source, and especially to a surface emitting device for use in a liquid crystal display (LCD) to improve the uniformity of brightness and efficiency of utilization of the LCD.

2. Description of the Related Art

Most users expect displays in portable devices, such as laptop and notebook computers, mobile phones and game devices, to have large, clear, bright viewing screens, equaling the performance of the cathode-ray-tube (CRT) monitors sitting on their desks. To meet this need, computer manufacturers have sought to build a flat panel display (FPD) offering superior resolution, color, and contrast, while at the same time requiring minimal power. LCDs are one type of FPD which satisfy these expectation. But because of the liquid crystals are not self-luminescent, LCDs need a surface emitting device which offers sufficient luminance (brightness) in a large variety of ambient light situations.

As shown in FIG. 5, a conventional surface emitting device 10, which is disclosed in a U.S. Pat. No. 6,219,117, has a lamp cover 11 whose interior is formed in a U-shape so as to encase a backlight source 13. A reflecting surface 11b, to which glossy processing is applied, forms an interior wall of an opening 11a of the lamp cover 11. The reflecting surface 11b reflects light emitted from the backlight source 13 forward, thereby irradiating the end surface 15a of a light guide plate 15. Furthermore, a bottom portion 11c to which the light guide plate 15 is fixed is formed as part of the integral lamp cover 11. A reflection sheet 17 is fixed on a bottom surface of the light guide plate 15 and secured between the bottom portion 11c and the light guide plate 15.

In operation, when an oblique light beam, indicated by the arrow C in FIG. 5, irradiates an end surface (not labeled) of the reflection sheet 17 adjacent to the backlight source 13, the reflected beam C1 is directly reflected out of the light guide plate 15. When another oblique light beam D irradiates a lower plane portion lid of the reflecting surface 11b, the oblique light beam D is reflected upward, and when the thus reflected light beam D1 enters the light guide plate 15 from the end surface 15a, it passes through the light guide plate 15 in a way similar to the reflected light beam C1. As a result, since the portion of the light guide plate 15 adjacent to the backlight source 13 is irradiated by the composite light beam composed of the first and second light beams C and D, that portion is made brighter than other areas of the light guide plate 15. Thus, there is a problem in that the brightness of the light guide plate 15 is made uneven by generation of “glittering state” emission lines.

In addition, referring to FIG. 6, little of the scattered light often enters into the light guide plate 15 being reflected by the reflecting surface 11b only once. On the contrary, most of the scattered beams are reflected a number of times before entering through the end surface 15a of the light guide plate 15. Unfortunately, each of these reflections costs energy, much of the light generated by the backlight source 13 are absorbed by the lamp cover 11 itself. As a result, the utilization of the backlight source 13 is poor.

### SUMMARY OF THE INVENTION

Accordingly, an object of the present invention is to provide a surface emitting device which has a more uniform brightness.

Another object of the present invention is to provide a surface emitting device which more efficiently utilizes the optical energy of a backlight source.

To achieve the above objects, a surface emitting device in accordance with a preferred embodiment of the present invention comprises a light source unit and an optical light guide plate which couples with incoming light from the light source unit. The light source unit comprises a light source and a lamp cover. The lamp cover is shaped substantially as a hexahedron and comprises a groove facing the light source. The groove is covered with a reflective film. With the reflective film, the groove functions as a concave mirror, and the light source is positioned at the focus of the concave mirror.

Other objects, advantages and novel features of the present invention will be apparent from the following detailed description of preferred embodiments thereof with reference to the attached drawings, in which:

### BRIEF DESCRIPTION OF THE DRAWINGS

FIG. 1 is a perspective view of a surface emitting device constructed in accordance with a preferred embodiment of the present invention;

FIG. 2 is perspective view of a light source unit of FIG. 1;

FIG. 3 is a schematic, cross-sectional view of FIG. 2;

FIG. 4 is a perspective view of a surface emitting device constructed in accordance with a second preferred embodiment of the present invention;

FIG. 5 is a schematic, cross-sectional view of a conventional surface emitting device, omitting a part thereof;

FIG. 6 is another schematic view of FIG. 5.

### DETAILED DESCRIPTION OF THE PREFERRED EMBODIMENTS

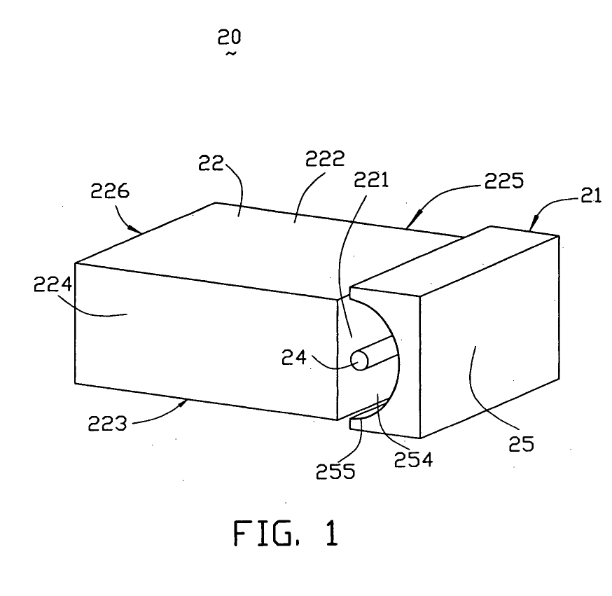

Referring to FIG. 1, a surface emitting device 20 in accordance with a preferred embodiment of the invention comprises a light source unit 21 and an optical light guide plate 22. The light source unite 21 is stationed to a side of the optical light guide plate 22. Light from the light source unit 21 couples with an optical input surface 221 of the optical light guide plate 22.

The light source unit 21 comprises a light source 24 and a lamp cover 25. The light source 24 typically is a linear source or a plurality of point sources which transmits scattered light beams, as shown in FIG. 3. In the preferred embodiment, the light source 24 is a cold cathode fluorescent lamp (CCFL). Alternatively, it can be one or more than one light emitting diode (LED).

The optical light guide plate 22 is substantially shaped as a rectangular plane plate and comprises the optical input surface 221 adjacent to the light source 24, an optical output surface 222, a bottom surface 223, a first and second side surfaces 224, 225, and a third side surface 226 opposite to the optical input surface 221. Typically, for the purpose of uniformly emitting light from the optical output surface 222, a plurality of reflective dot-patterns (not shown) are integrally formed on the bottom surface 223. To improve optical performance efficiency, reflective sheets or films (not shown) can be secured on the bottom surface 223 and the three side surfaces 224, 225, 226. The use of the reflective sheets or films ensures that virtually all the optical light beams from the light source 24 are emitted from the optical output surface 222.

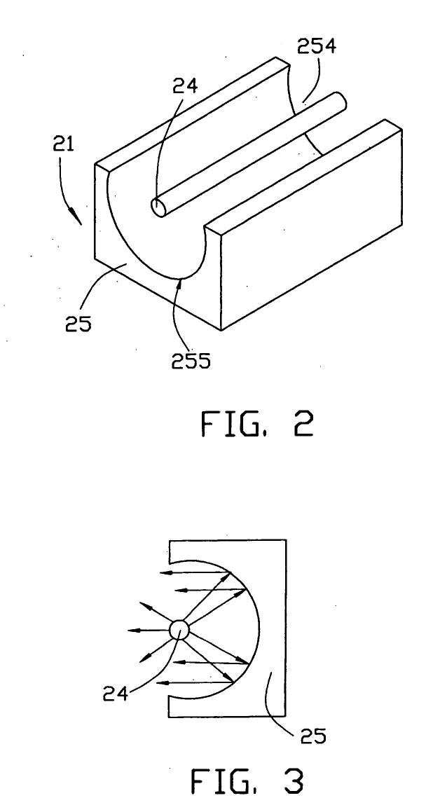

Turning to FIGS. 2 and 3, the lamp cover 25 of the light source unit 21 is substantially shaped as a hexahedron. A groove 254 is defined in one side of the lamp cover 25. The groove 254 faces to the CCFL 24. An opening of the groove 254 is substantially as wide as or slightly wider than a height of the input surface 221 of the optical light guide plate 22. A reflective film 255 is attached on an inner surface (not labeled) of the groove 254. Of course, the inner surface can be polished to a reflective surface instead of a reflective film thereto. With the reflection film 255, the groove 254 functions as a concave mirror, the concave mirror forms a physical focus line, and the CCFL 24 is positioned along the focus line.

In operation, the CCFL 24 be considered to be a plurality of point light sources, each positioned on a focal point of a cross-sectional slice of the concave mirror. Light beams emitted from a side of the point light sources facing the reflective film 255 are reflected to parallel optical beams by the concave mirror, as shown in FIG. 3. These parallel beams enter into the light guide plate 22 through the optical input surface 221. The light beams emitted from a side of the point light sources opposite to the reflective film 255 directly enter into the light guide plate 22 through the optical input surface 221 (see FIG. 3). All the optical beams emitted by the CCFL 24 need, at most only one reflection prior to entering into the light guide plate 22. In contrast to the prior art, optical utilization efficiency is increased.

Furthermore, about 50 percent of the light emitted by the CCFL 24 is converted to parallel light by the lamp cover 25, so enters into the light guide plate 22 at a same angle, and is transmitted in the light guide 22 to the third side surface 226 away from the CCFL 24. The remaining light which enters the light guide plate 22 without reflecting from the reflective film 255, is transmitted into the light guide plate 22 and may reflect for a period within then be outputted through the output surface 222, or may be immediately outputted through the output surface 222. The light transmitting in the light guide plate 22 is thus balanced, and in contrast to the prior art, does not get emitted in a larger concentration at an end adjacent to the CCFL 24. Thus, the brightness of the light guide plate 22 is more uniform over the optical output surface 222.

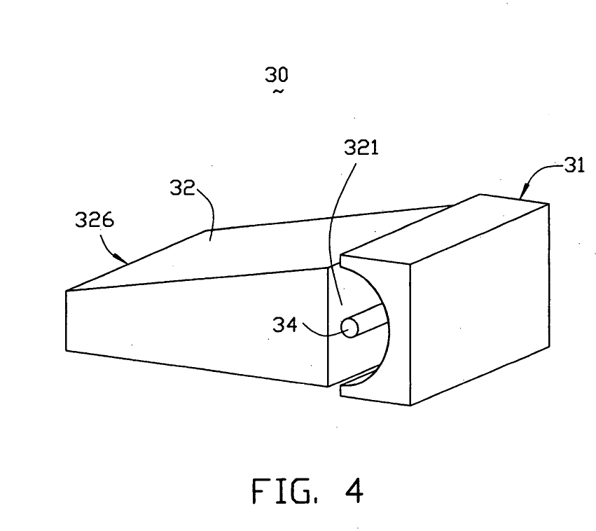

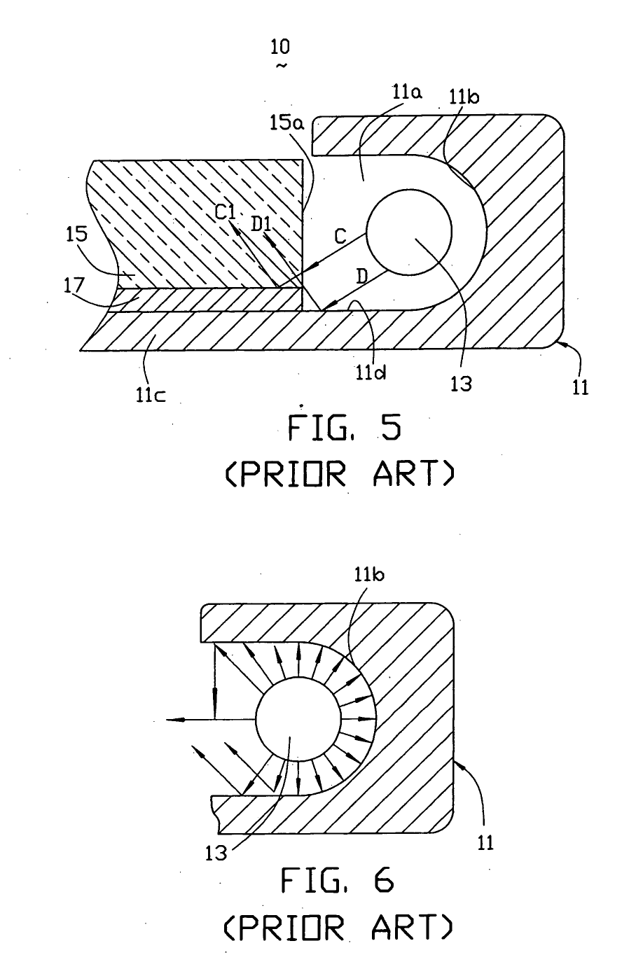

Turning to FIG. 4, another surface emitting device 30 in accordance with a second preferred embodiment of the invention is structured similar to the surface emitting device 20. The difference therebetween is the light guide plate 32 is shaped like a wedge. The height of the input surface 321 is equal to or slightly smaller than the opening of the lamp cover 31. A height of the third surface 326 of the light guide 32 is less than that of the input surface 321, or tends to zero.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A surface emitting device comprising:
a light source unit comprising a lamp cover and a light source, the lamp cover being substantially shaped as a hexahedron and defining a groove therein which faces to the light source; and
a light guide plate optically coupled with the light source unit;
wherein a reflective film is positioned on an inner surface of the groove, the combination of the lamp cover and the reflective film functions as a concave mirror, and the light source is positioned at a focal point of the mirror.

2. The surface emitting device as described in claim 1, wherein the light source is a cold cathode fluorescent lamp.

3. The surface emitting device as described in claim 1, wherein the light source is one or more light emitting diodes.

4. The surface emitting device as described in claim 1, wherein the light source unit is positioned at one side of the light guide plate.

5. The surface emitting device as described in claim 1, further comprising a reflective film attached on a bottom surface of the light guide plate.

6. The surface emitting device as described in claim 1, wherein a width of the groove is equal to or slightly larger than a height of the light guide plate.

7. The surface emitting device as described in claim 1, further comprising a reflective sheet covering a bottom surface of the light guide plate.

8. The surface emitting device as described in claim 1, wherein the light guide plate is substantially shaped as a rectangular plane plate and comprises an optical input surface adjacent to the light source, an optical output surface, a bottom surface, first and second side surfaces, and a third side surface opposite to the optical input surface, the bottom surface having a plurality of dot-patterns thereon.

9. The surface emitting device as described in claim 8, wherein an opening of the groove is as wider as or slightly wider than a height of the optical input surface.

10. The surface emitting device as described in claim 1, wherein the optical light guide plate is substantially shaped as a wedge.

11. An optical unit for illuminating a liquid crystal display comprising:
a light guide plate;
a light source illuminating the light guide plate; and
a lamp cover having a reflective surface adjacent to the light source, wherein the reflective surface substantially forms a concave mirror, and the light source is positioned at a focal point of the concave mirror.

12. The optical unit as described in claim 11, wherein the reflective surface of the lamp cover is polished to a reflective surface.

13. The optical unit as described in claim 11, wherein the reflective surface of the lamp cover comprises a reflective film attached thereon.

14. The optical unit as described in claim 11, wherein the light source is a cold cathode fluorescent lamp.

15. The optical unit as described in claim 11, wherein the light source is one or more light emitting diodes.

16. The optical unit as described in claim 11, wherein the light source and the lamp cover are positioned at one side of the light guide plate.

17. The optical unit as described in claim 1, wherein the light guide plate is shaped as a flat plate.

18. The optical unit as described in claim 1, wherein the light guide plate is shaped as a wedge.

19. The optical unit as described in claim 11, wherein said light source is located substantially flush with an outermost opening face of said concave mirror.

20. An optical unit comprising:
a light guide plate defining a rectangular configuration;
a light source closely located beside one edge of said rectangular configuration; and
a lamp cover closely located beside said light source opposite to said light guide plate; wherein
said lamp cover defines a semi-columnar like groove, and said light source defines a relatively small columnar configuration coaxially located around a center of said semi-columnar like groove.
